(19) United States
(12) Patent Application Publication
(10) Pub. No.: US 2004/0079496 A1
(43) Pub. Date: Apr. 29, 2004

(54) Advertising medium and vehicle windshield sun visor

(76) Inventors: David Schoelles, Scottsdale, AZ (US); Mark Vandeveer, Marion, IL (US)

Correspondence Address: ELLIS & VENABLE, PC, 101 NORTH FIRST AVE., SUITE 1875, PHOENIX, AZ, 85003, US

(21) Appl. No.: 10/687,029

(22) Filed: Oct. 16, 2003

Related U.S. Application Data
(60) Provisional application No. 60/419,679, filed on Oct. 16, 2002.

(51) Int. Cl. B60J 3/00

(52) U.S. Cl. 160/370.21

(57) ABSTRACT

The present invention is a targeted marketing sun visor for a vehicle windshield. Generally, the targeted marketing sun visor comprises a pliable body having an interior side and an exterior side, the interior side having a plurality of information components directed to a targeted group. It is preferred that the information components include, but are not limited to, advertisements, maps, an index of advertisers, and a tracking device for incentive identification. The exterior side of the targeted marketing sun visor can contain artwork. It is preferred that the artwork be directed to the targeted group.

### CROSS-REFERENCE TO RELATED APPLICATION

The present application claims priority to copending U.S. provisional application entitled “Advertising Medium and Windshield Sun Visor,” having serial No. 60/419,679, filed by inventors David Schoelles and Mark Vandeveer, which is entirely incorporated herein by reference.

### BACKGROUND OF THE INVENTION

1. Field of the Invention

This invention is relevant to the field of vehicle sun visors.

2. Discussion of the Related Art

Vehicle sun visors help reduce the interior temperature of a vehicle parked in the sun and help reduce premature deterioration of a vehicle's interior as a result of exposure to sunlight. A variety of vehicle sun visors are known. None, however, disclose the aspects of the current invention.

### SUMMARY OF THE DESCRIPTION

The invention is summarized below only for purposes of introducing embodiments of the invention. The ultimate scope of the invention is to be limited only to the claims that follow the specification.

The present invention is a targeted marketing sun visor for a vehicle windshield. Generally, the targeted marketing sun visor comprises a pliable body having an interior side and an exterior side, the interior side having a plurality of information components directed to a targeted group. It is preferred that the information components include, but are not limited to, advertisements, maps, an index of advertisers, and a tracking device for incentive identification. The exterior side of the targeted marketing sun visor can contain artwork. It is preferred that the artwork be directed to the targeted group.

The description of the invention which follows, together with the accompanying drawings should not be construed as limiting the invention to the example shown and described, because those skilled in the art to which this invention appertains will be able to devise other forms thereof within the ambit of the appended claims.

### BRIEF DRAWING DESCRIPTIONS

The drawings depict one or more embodiments incorporating one or more aspects of the invention but are not determinative of the scope of the claims that follow this description.

FIG. 1 illustrates an interior view of the preferred embodiment of the targeted marketing sun visor 8.

### DESCRIPTIONS OF EMBODIMENTS

It is to be understood that the descriptions below are merely illustrative of the presently preferred embodiments of the invention and that no limitations are intended to the detail of construction or design herein shown other than as defined in the appended claims.

The present invention is a vehicle sun visor that protects automobiles from the sun. In addition to sun protection, the sun visor (referred to herein as the “targeted marketing sun visor”) also provides information components directed to targeted groups. For the purpose of this patent application, the term “information component” means any information that could be useful to a person using the vehicle, including advertisements, maps, telephone numbers, index of vendors, etc. The information components 16 can convey the desired information using a variety of means, including digital format and/or digital projection. It is preferred, though, to permanently fix the information to the information sun visor in written or printed form.

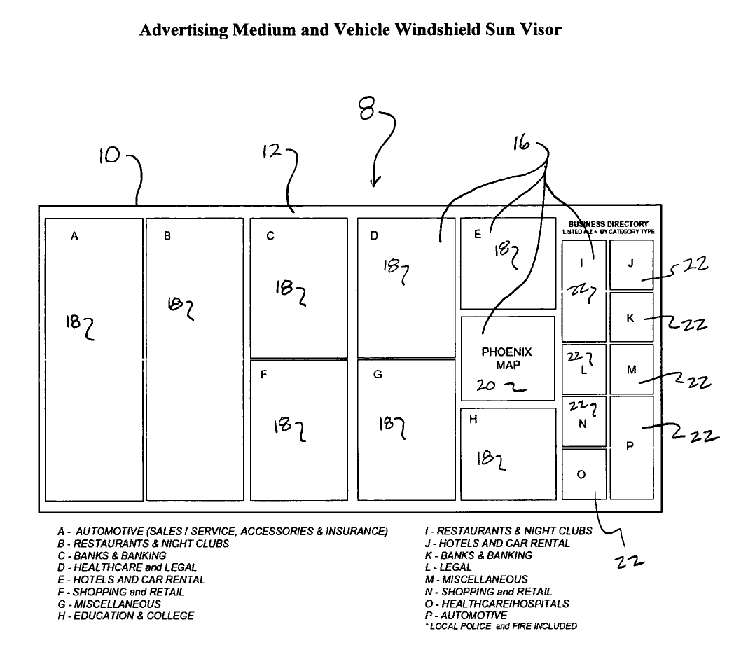

FIG. 1 illustrates the preferred embodiment of the targeted marketing sun visor 8. FIG. 1 shows a pliable body 10 having an interior side 12. While not necessary, it is preferred that the targeted marketing sun visor 8 be pliable so that it can be folded or otherwise stored when not in use and easily manipulated into position when needed shield the vehicle from the sun. The targeted marketing sun visor 8 is scaleable to various sizes but the preferred dimensions are 60 inches in width and 22-28 inches in height.

It is preferred information components 16 be directed to a targeted group. The targeted group can be any group of people with a common interest. Three examples of potential target groups include: (1) those affiliated with a college campus platform (2) those affiliated with a city or geographic locale, or (3) those affiliated with given business sector (e.g., tourism). The information components 16 can be selected and marketed to reflect the perceived interests of the targeted group. The target group can vary depending upon the business densities and logical boundaries of commerce areas.

It is preferred that the information components 16 include items like maps, vendor lists, telephone numbers, coupons. It is also preferred that the information components 16 be grouped together in an organized fashion to facilitate ease of locating the information needed. FIG. 1 illustrates a preferred layout of information components 16 including sections organized for the following areas: automotive (sales/service, accessories & insurance), restaurants & night clubs, banks & banking, healthcare and legal, hotels & car rental, shopping & retail, miscellaneous, education and college, local police & fire and maps. FIG. 1 also illustrates the preferred layout having an advertisements grouped in an organized fashion and a separate section for an index, which is also grouped in an organized fashion.

It is preferred that at least one of the information components 16 include advertisements 18 directed to the targeted group. Preferably, the advertisements are for participating businesses in the targeted area and comprise ads targeted to the automobile driver. The driver will most likely see these ads as the targeted marketing sun visor 8 is folded and unfolded each day. The space ads are used to key attention quicker than the text listing.

It is preferred that at least one of the information components 16 include a map 20. The map indicates major highways, streets and town limits in the target area. The driver is encouraged to use the map while searching for businesses and visa versa. It is preferred that the map be in two colors and be contained in a 5-inch square space on the interior side 12. The targeted marketing sun visor 8 can be used to make appointments and includes a map for directions.

It is also preferred that at least one of the information components 16 include a business index 22. The business index 22 is a list of participating businesses or restaurants in the targeted area. It is preferred that the business index 22 include the businesses advertised on the targeted marketing visor 8. It is preferred that the business index 22 be organized in alphabetical order for easy viewing and searching. The business index 22 list can also serve as a directory of goods or services needed while driving in an automobile. It is preferred that the business index 22 is a list of businesses that are within the targeted area and targeted to automobile drivers and passengers.

Likewise, it is also preferred that the information components 16 include a tracking device for incentive identification. The ID tracking program allows advertisers and/or participating businesses to make incentive offers and discounts for the motorists. It is preferred that the discounts be traced. It is also preferred to employ a bounce back program to create new business. A bounce back program uses a media vehicle to attract customers to continue using a product or service. Examples of bounce back programs include discounts, a frequency rebates or free gifts. In one embodiment, restaurant customers receive a bounce back ID member card. This card has coupons on the reverse side and serves as a reminder of the targeted marketing sun visor 8.

The pliable body 10 also has an exterior side. The exterior side is located on the side of the pliable body 10 that is opposite of the interior side 12. It is preferred that the exterior side of the targeted marketing sun visor 8 includes artwork. The artwork can be of any type, including scenic photography, graphic designs, logos, etc. It is preferable that the artwork be of the scenery in the given targeted geographical area. (i.e., a given town or area). It is preferred that the artwork be directed to the targeted group.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

What is claimed is:

1. An targeted marketing sun visor for a vehicle windshield, the targeted marketing sun visor comprising
a pliable body having an interior side and an exterior side, the interior side having a plurality of information components directed to a targeted group.

2. The targeted marketing sun visor of claim 1, the information components further comprising an advertisement.

3. The targeted marketing sun visor of claim 1, wherein the information components are organized by categories selected from the group consisting of automotive sales, automotive service, accessories, insurance, restaurants, night clubs, banks, banking, healthcare, legal, hotels, car rental, shopping, retail, miscellaneous, education, college, local police, fire and maps.

4. The targeted marketing sun visor of claim 1, the information components further comprising a map.

5. The targeted marketing sun visor of claim 1, the information components further comprising a business index.

6. The targeted marketing sun visor of claim 5, wherein the business index is organized by categories selected from the group consisting of automotive, sales, automotive service, accessories, insurance, restaurants, night clubs, banks, banking, healthcare, legal, hotels, car rental, shopping, retail, miscellaneous, education, college, local police, fire and maps.

7. The targeted marketing sun visor of claim 1, the information components further comprising a tracking device for incentive identification.

8. The targeted marketing sun visor of claim 1, the exterior side further comprising artwork.

9. The targeted marketing sun visor of claim 8, wherein the artwork is directed to the targeted group.
